(19) United States
(12) Patent Application Publication
(10) Pub. No.: US 2018/0100555 A1
(43) Pub. Date: Apr. 12, 2018

(54) Unidirectional Rotating Brake

(71) Applicant: Tai-World Mfg. Co., Ltd., Changhua City (TW)

(72) Inventor: Sen-Tien Shih, Changhua City (TW)

(21) Appl. No.: 15/291,261

(22) Filed: Oct. 12, 2016

(51) Int. Cl. F16D 59/00

(52) U.S. Cl. CPC F16D 59/00; F16D 2127/10

(57) ABSTRACT

A unidirectional rotating brake contains: a body including a first rotation element and a second rotation element between which a first mating face and a second mating face are formed. The second mating face has multiple accommodation grooves, each of which has a first segment and a second segment. The second rotation element further has multiple circular loops and a stop ring, each of the multiple circular loops has multiple notches, and each of the multiple notches accommodates each of multiple connection columns. Each of multiple locking elements has a diameter which is less than a depth of the first segment of said each accommodation groove and is more than a depth of the second segment. The unidirectional rotating brake further contains at least one returning member configured to drive said each locking element to move toward the second segment of said each accommodation groove.

### BACKGROUND OF THE INVENTION

### Field of the Invention

The present invention relates to a clutch, and more particularly to a unidirectional rotating brake which is applicable for power machines so as to transmit torque in a single direction.

### Description of the Prior Art

A conventional unidirectional rotating brake prevents inverse rotation and transmits torque in a single direction. As rotating the conventional unidirectional rotating brake in a reverse direction, its driving member rotates idly. The conventional unidirectional rotating brake is applicable for power machines, such as bicycles, motorcycles, or rotation tools.

With reference to FIGS. 13 and 14, a conventional unidirectional rotating brake contains a rotary driving member 91, a rotary driven member 92, a plurality of rolling posts 93, and multiple springs 94, wherein the rotary driving member 91 has a first mating face 911 formed on an outer wall thereof, and the rotary driven member 92 has a second mating face 921 on which multiple accommodation grooves 922 are equidistantly arranged, wherein each of the multiple accommodation grooves 922 has a first segment 9221 and a second segment 9222, and a depth of the first segment 9221 is more than that of the second segment 9222, each of the plurality of rolling posts 93 and the multiple springs 94 is housed in said each accommodation groove 922, and said each rolling post 93 is pushed by said each spring 94 to move to the second segment 9222 from the first segment 9221, such that said rolling post 93 returns back to an original position.

When the rotary driving member 91 rotates to a first direction in relation to the rotary driven member 92, said each rolling post 93 is pushed by said each spring 94 and is urged by the first mating face 911 to move toward the second segment 9222 of said each accommodation groove 922, hence said each rolling post 93 is fixed between said each accommodation groove 922 and the first mating face 911, and the rotary driving member 91 drives the rotary driven member 92 to revolve. When the rotary driving member 91 rotates toward a second direction opposite to the first direction with respect to the rotary driven member 92, said each rolling post 93 is urged by the first mating face 911 to move toward the first segment 9221 of said each accommodation groove 922, such that said each rolling post 93 presses said each spring 94 and removes from said each accommodation groove 922 and the first mating face 911, and the rotary driving member 91 rotates idly in relation with the rotary driven member 92.

Referring to FIGS. 15 and 16, another conventional unidirectional rotating brake contains a rotary driving member 91, a rotary driven member 92, a plurality of rolling posts 93, and multiple magnets 95, wherein the rotary driving member 91 has a first mating face 911 formed on an outer wall thereof, and the rotary driven member 92 has a second mating face 921 on which multiple accommodation grooves 922 are equidistantly arranged, wherein each of the multiple accommodation grooves 922 has a first segment 9221 and a second segment 9222, and a depth of the first segment 9221 is more than that of the second segment 9222, each of the plurality of rolling posts 93 is housed in said each accommodation groove 922, and each of the multiple magnets 922 is accommodated in said each accommodation groove 922 close to the second segment 9222, such that said each rolling post 93 is pushed by a magnetic force of said each magnet 922 to move toward the second segment 9222, thus returning back to an original position.

When the rotary driving member 91 rotates to a first direction in relation to the rotary driven member 92, said each rolling post 93 is pushed by the magnetic force of said each magnet 95 and is urged by the first mating face 911 to move toward the second segment 9222 of said each accommodation groove 922, hence said each rolling post 93 is fixed between said each accommodation groove 922 and the first mating face 911, and the rotary driving member 91 drives the rotary driven member 92 to revolve. When the rotary driving member 91 rotates toward a second direction opposite to the first direction with respect to the rotary driven member 92, said each rolling post 93 is urged by the first mating face 911 (its driving force is more than the magnetic force of said each magnet 95) to move toward the first segment 9221 of said each accommodation groove 922, such that said each rolling post 93 removes from said each accommodation groove 922 and the first mating face 911, and the rotary driving member 91 rotates idly in relation with the rotary driven member 92.

However, the multiple accommodation grooves 922 of these conventional unidirectional rotating brakes are machined in high accuracy and strength, so they are made of certain materials with high hardness and are machined by a computer numerical control (CNC) machine, thus increasing production cost and complicated machining process.

The present invention has arisen to mitigate and/or obviate the afore-described disadvantages.

### SUMMARY OF THE INVENTION

The primary objective of the present invention is to provide a unidirectional rotating brake which contains a second mating face and a second rotation element which has a plurality of accommodation grooves, multiple circular loops, and a stop ring, wherein the multiple circular loops are stamped, cut, and stacked together easily without using a CNC machine, thus reducing production cost and enhancing market competitiveness.

A unidirectional rotating brake provided by the present invention contains: a body including a first rotation element and a second rotation element between which a first mating face and a second mating face are formed.

The first mating face is a flat surface, and the second mating face has a plurality of accommodation grooves equidistantly arranged on the second mating face, each of the plurality of accommodation grooves has a first segment and a second segment, and a depth of the first segment is more than a depth of the second segment, the second rotation element further has multiple circular loops, wherein the multiple circular loops stack together and are in a same shape, each of the multiple circular loops has a plurality of notches which do not communicate with the plurality of accommodation grooves, and each of the plurality of notches accommodates each of multiple connection columns, such that the first rotation element and the second rotation element are connected together.

Each of multiple locking elements is circular and is accommodated in said each accommodation groove of the second mating face, such that said each locking element moves in said each accommodation groove, wherein said each locking element has a diameter which is less than a depth of the first segment of said each accommodation groove of the second mating face and is more than a depth of the second segment of said each accommodation groove of the second mating face.

### BRIEF DESCRIPTION OF THE DRAWINGS

FIG. 1 is a perspective view showing the exploded components of a unidirectional rotating brake in accordance with a first embodiment of the present invention.

FIG. 2 is another perspective view showing the exploded components of the unidirectional rotating brake in accordance with the first embodiment of the present invention.

FIG. 3 is a perspective view showing the assembly of the unidirectional rotating brake in accordance with the first embodiment of the present invention.

FIG. 4 is a cross sectional view showing the assembly of the unidirectional rotating brake in accordance with the first embodiment of the present invention.

FIG. 5 is a side plane view showing the assembly of the unidirectional rotating brake in accordance with the first embodiment of the present invention.

FIG. 6 is a cross sectional view of a part of FIG. 5.

FIG. 7 is a side plane view showing the operation of the unidirectional rotating brake in accordance with the first embodiment of the present invention.

FIG. 8 is another side plane view showing the operation of the unidirectional rotating brake in accordance with the first embodiment of the present invention.

FIG. 9 is a side plane view showing the assembly of a unidirectional rotating brake in accordance with a second embodiment of the present invention.

FIG. 10 is a side plane view showing the assembly of a unidirectional rotating brake in accordance with a third embodiment of the present invention.

FIG. 11 is a perspective view showing the exploded components of a unidirectional rotating brake in accordance with a fourth embodiment of the present invention.

FIG. 12 is a side plane view showing the assembly of a unidirectional rotating brake in accordance with a fifth embodiment of the present invention.

FIG. 13 is a perspective view showing the exploded components of a conventional unidirectional rotating brake.

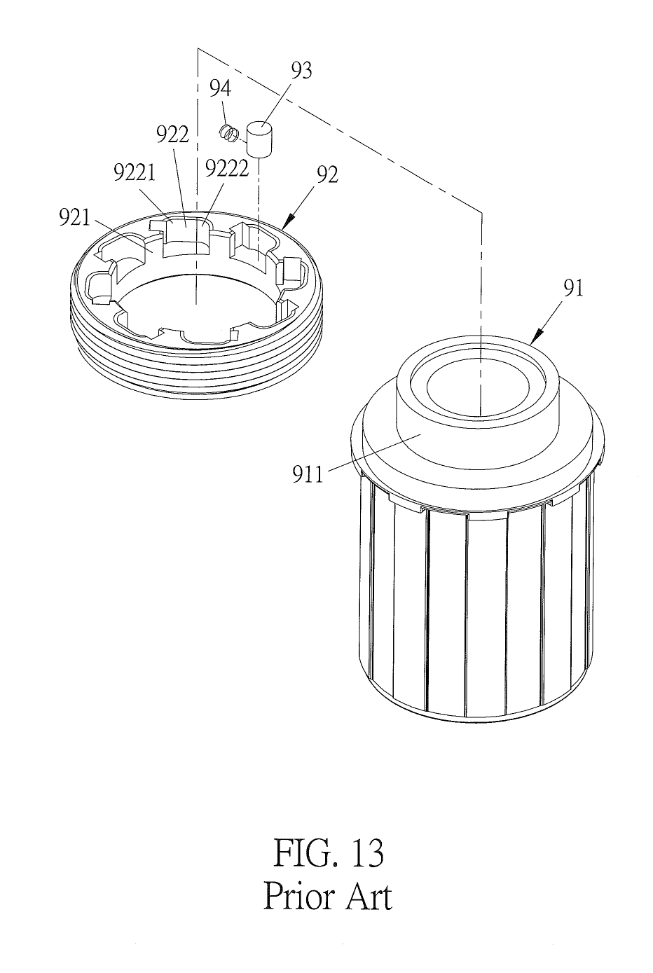

FIG. 14 is a side plane view showing the assembly of the conventional unidirectional rotating brake.

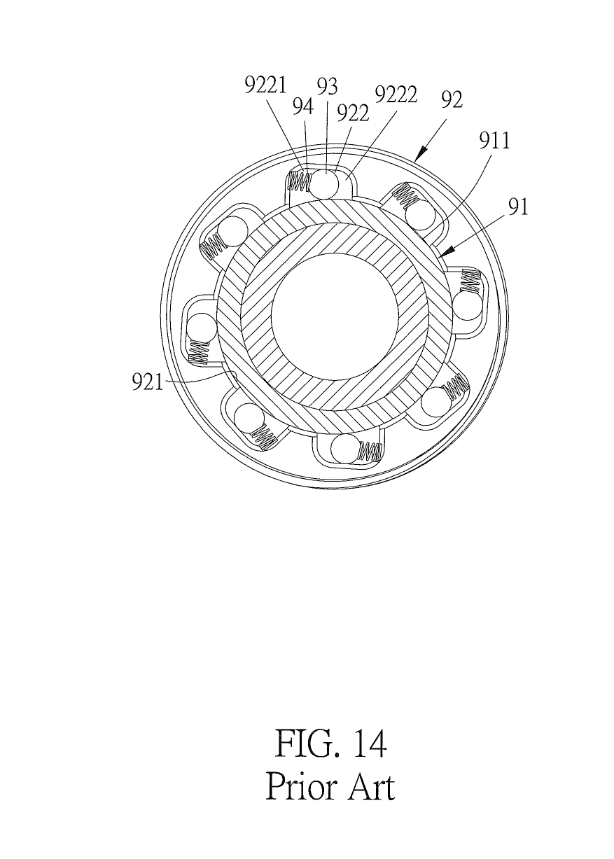

FIG. 15 is a perspective view showing the exploded components of another conventional unidirectional rotating brake.

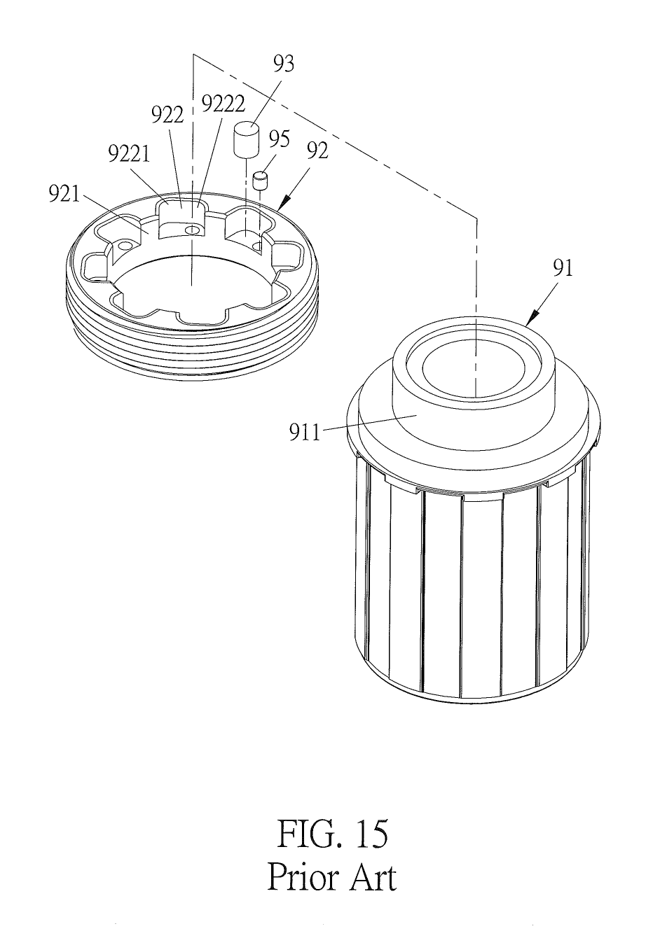

FIG. 16 is a side plane view showing the assembly of said another conventional unidirectional rotating brake.

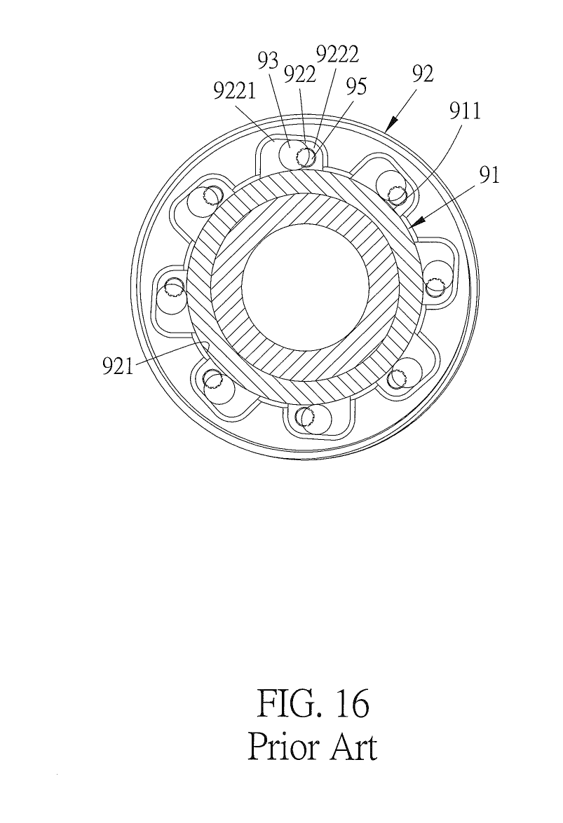

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

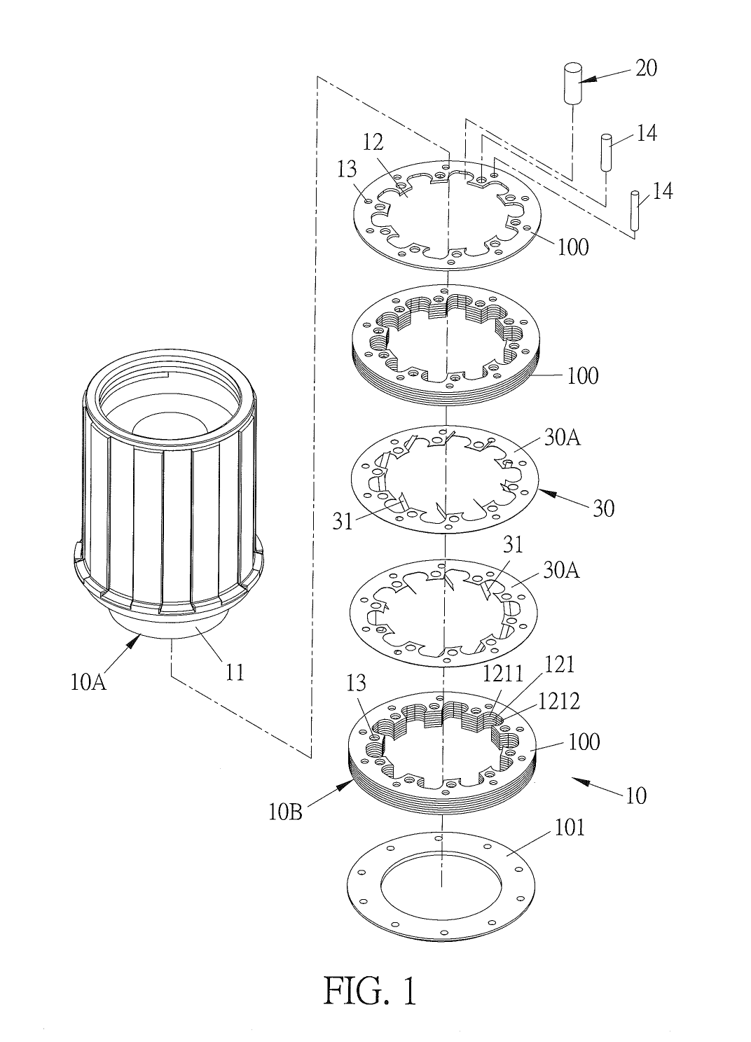

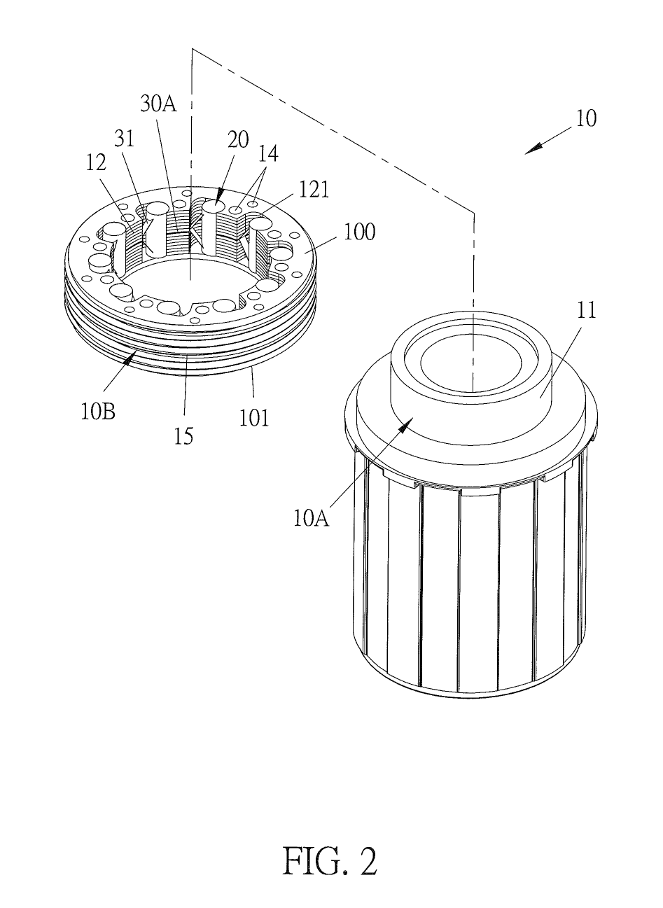

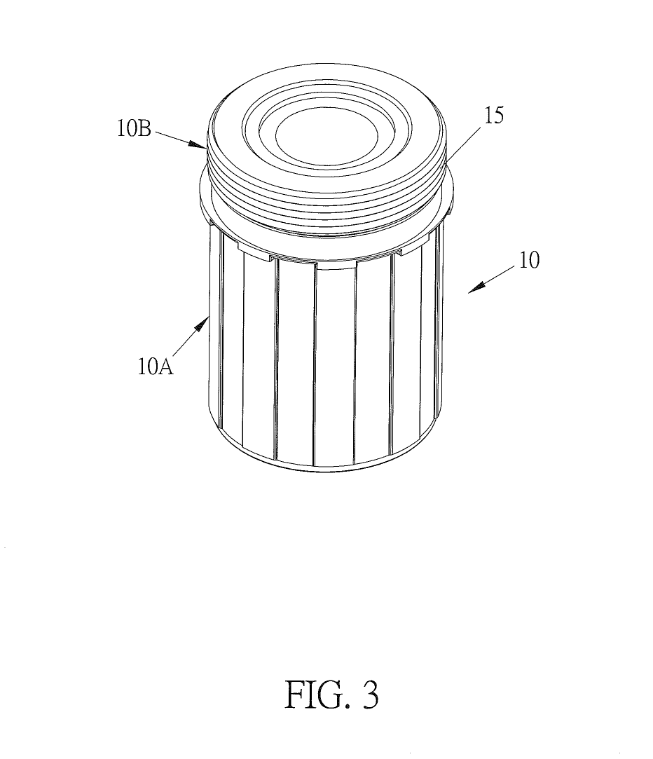

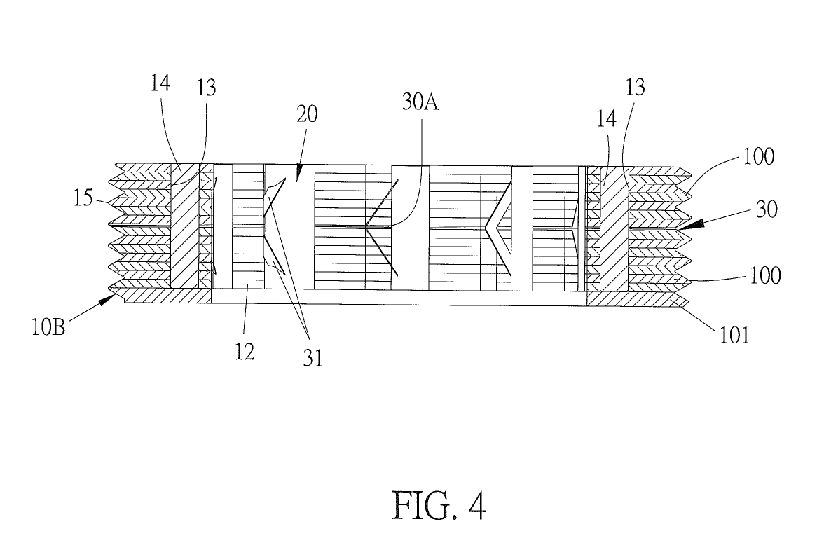

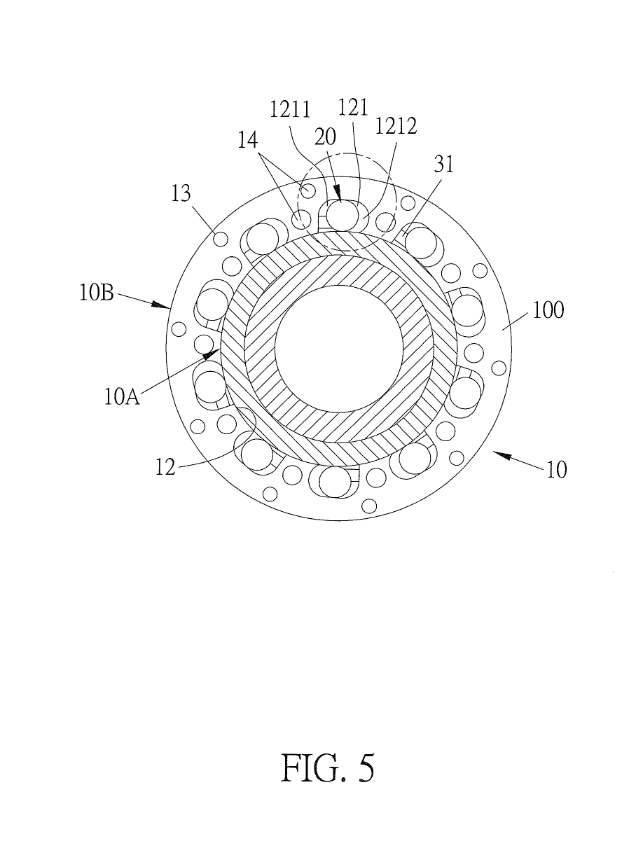

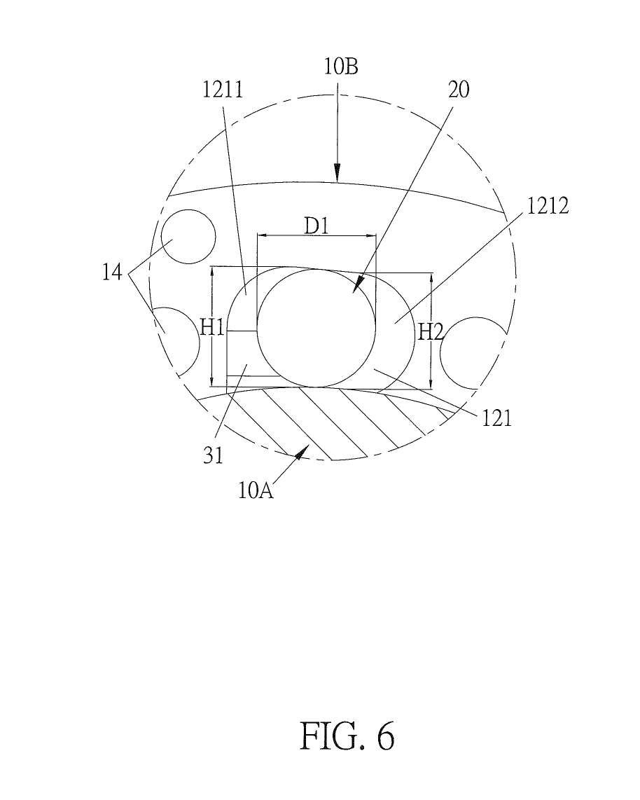

Referring to FIGS. 1-6, a unidirectional rotating brake according to a first embodiment of the present invention comprises: a body 10, multiple locking elements 20, and at least one returning member 30.

The body 10 includes a first rotation element 10A and a second rotation element 10B between which a first mating face 11 and a second mating face 12 are formed, wherein the first mating face 11 is a flat surface and forms on the first rotation element 10A, and the second mating face 12 forms on the second rotation element 10B and has a plurality of accommodation grooves 121 equidistantly arranged on the second mating face 12, wherein each of the plurality of accommodation grooves 121 has a first segment 1211 and a second segment 1212, and a depth of the first segment 1211 is more than a depth of the second segment 1212. The second rotation element 10B further has multiple circular loops 100 and a stop ring 101, wherein the multiple circular loops 100 stack together and are in a same shape, said each accommodation groove 121 forms on the multiple circular loops 100, and the stop ring 101 stacks on one side of the multiple circular loops 100 so as to close said each accommodation groove 121. Each of the multiple circular loops 100 has a plurality of notches 13 which do not communicate with the plurality of accommodation grooves 121, and some of the plurality of notches 13 communicate with the stop ring 101, wherein each of the plurality of notches 13 accommodates each of multiple connection columns 14, such that the multiple circular loops 100 and the stop ring 101 are connected together. Furthermore, the second rotation element 10B has screwing threads 15 arranged around an outer wall thereof. Alternatively, the first mating face 11 forms on the second rotation element 10B, and the second mating face 12 forms on the first rotation element 10A.

Each of the multiple locking elements 20 is circular (for example, said each locking element 20 is a rolling post or a rolling ball). In this embodiment, said each locking element 20 is the rolling post and is housed in said each accommodation groove 121 of the second mating face 12, such that said each locking element 20 moves in said each accommodation groove 121. Said each locking element 20 has a diameter D1 which is less than the depth H1 of the first segment 1211 of said each accommodation groove 121 of the second mating face 12 and is more than the depth H2 of the second segment 1212 of said each accommodation groove 121 of the second mating face 12.

The at least one returning member 30 is two circular flexible loops 30A stacked together and clamped among the multiple circular loops 100 of the second rotation element 10B, and a profile of each of the two circular flexible loops 30A corresponds to said each circular loop 100. Each of the two circular flexible loops 30A has multiple abutting portions 31 in a V shape, each of the multiple abutting portions 31 extends into said each accommodation groove 121 of the second mating face 12 of the second rotation element 10B so as to abut against said each locking element 20, hence said each locking element 20 automatically moves to an original position via the second segment 1212.

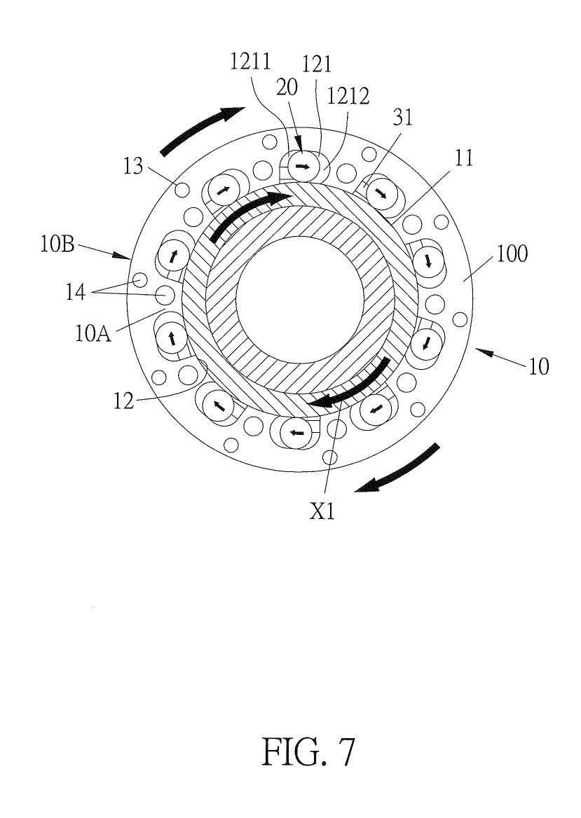

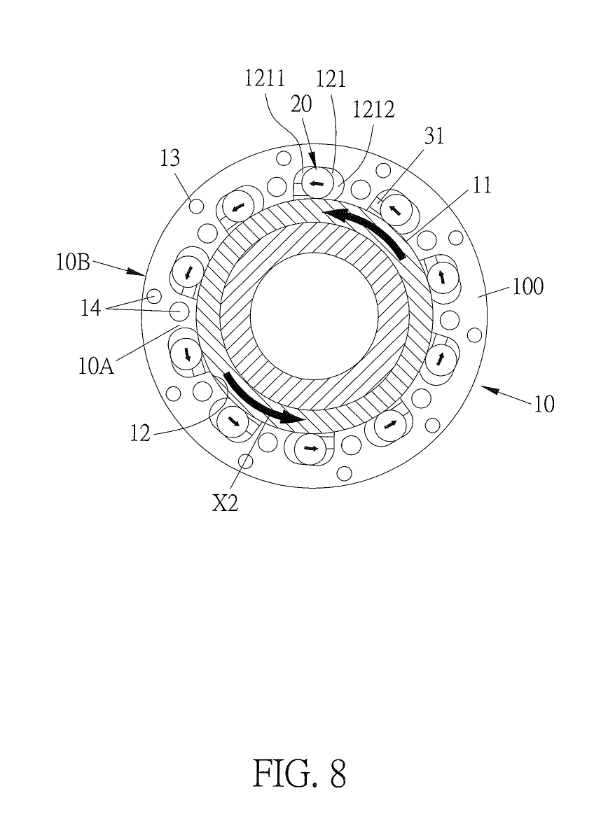

In operation, as shown in FIG. 7, when the first rotation element 10A rotates toward a first direction X1 relative to the second rotation element 10B, said each locking element 20 is pushed by said each abutting portion 31 of said each circular flexible loop 30A and is driven by the first mating face 11 to move toward the second segment 1212 of said each accommodation groove 121, hence said each locking element 20 is forced between said each accommodation groove 121 and the first mating face 11, and the first rotation element 10A drives the second rotation element 10B to revolve. When the first rotation element 10A rotates toward a second direction X2 opposite to the first direction X1 in relation with the second rotation element 10B, as illustrated in FIG. 8, said each locking element 20 is driven by the first mating face 11 to move toward the first segment 1211 of said each accommodation groove 121 so as to press said each abutting portion 31 of said each circular flexible loop 30A so that said locking element 20 removes from said each accommodation groove 121 and the first mating face 11, and the first rotation element 10A rotates idly relative to the second rotation element 10B.

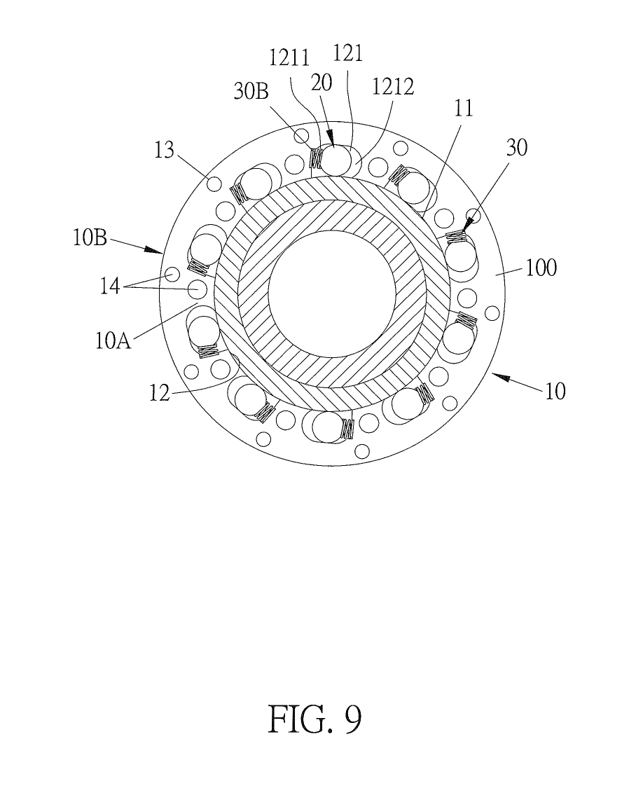

Referring to FIG. 9, in a second embodiment, the at least one returning member 30 is multiple springs 30B, each of the multiple springs 30B is housed in said each accommodation groove 121 of the second mating face 12, such that said each locking element 20 moves from the first segment 1211 to the second segment 1212 in said each accommodation groove 121, thus moving back to an original position.

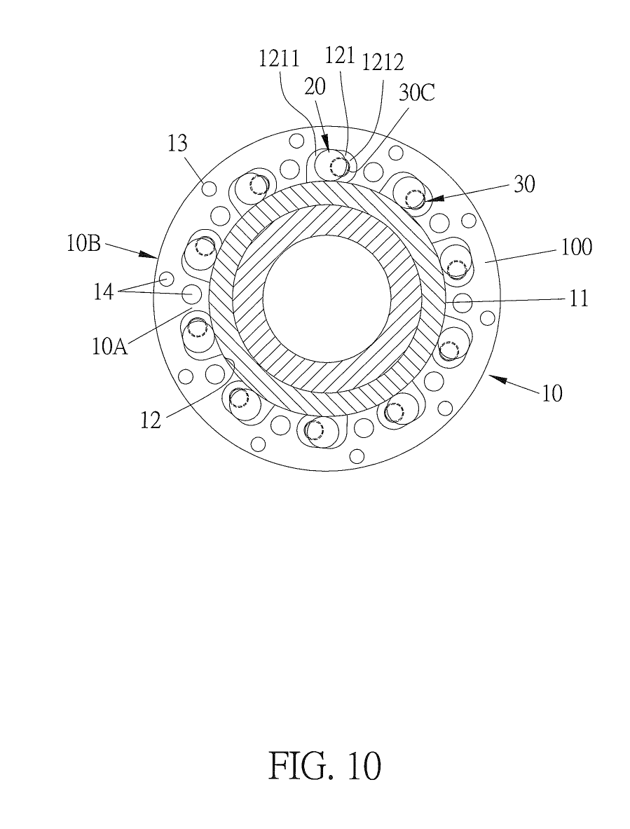

With reference to FIG. 10, in a third embodiment, the at least one returning member 30 is multiple magnets 30C, wherein each of the multiple magnets 30C is accommodated in said each accommodation groove 121 close to the second segment 1212, and said each locking element 20 moves toward the second segment 1212 to as to move back to an original position by using said each magnet.

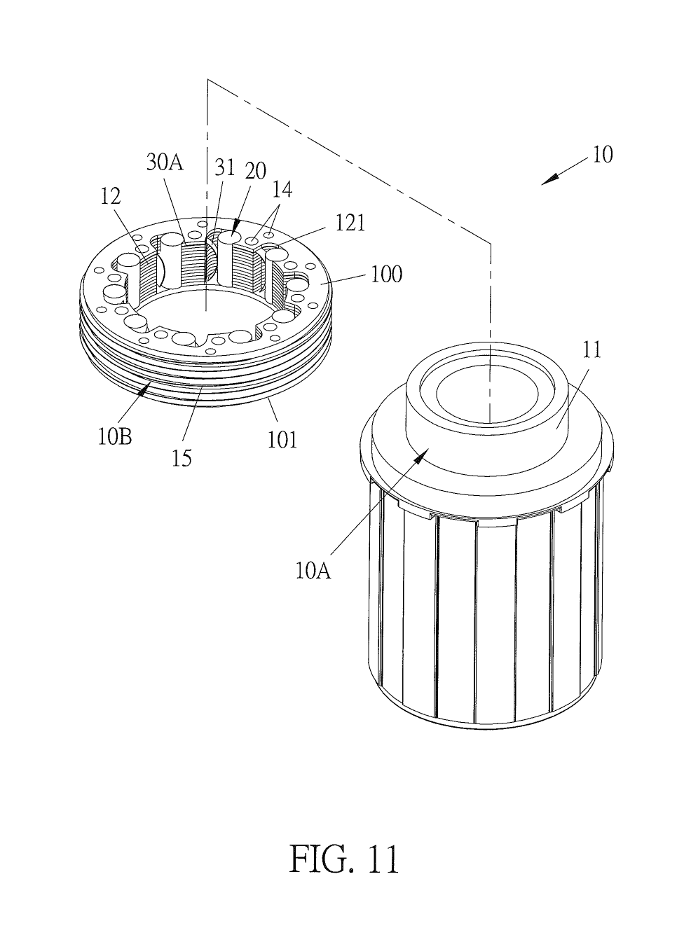

With reference to FIG. 11, in a fourth embodiment, the at least one returning member 30 is a resilient sleeve 30A clamped among the multiple circular loops 100 of the second rotation element 10B, and the resilient sleeve 30A includes multiple arcuate retaining ribs 31, each of the multiple arcuate retaining ribs 31 extends into said each accommodation groove 121 of the second mating face 12 of the second rotation element 10B so as to push said each locking element 20, and said each locking element 20 moves toward the second segment 1212 of said each accommodation groove 121, thus moving back to an original position.

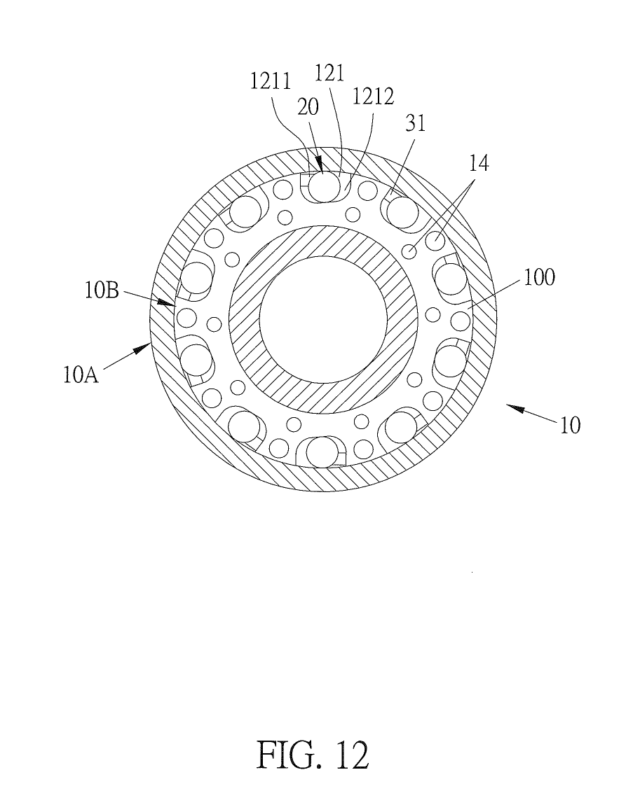

Referring to FIG. 12, in a fifth embodiment, the first mating face 11 of the body 10 forms on the second rotation element 10B, and the second mating face 12 forms on the first rotation element 10A.

The unidirectional rotating brake of the present invention contains the second mating face 12 and the second rotation element 10B which has the plurality of accommodation grooves 121, the multiple circular loops 100, and the stop ring 101. Preferably, the multiple circular loops 100 and the stop ring 101 are stamped, cut, and stacked together easily without using a CNC machine, thus reducing production cost and enhancing market competitiveness.

While we have shown and described various embodiments in accordance with the present invention, it is clear to those skilled in the art that further embodiments may be made without departing from the scope of the present invention.

What is claimed is:

1. A unidirectional rotating brake comprising: a body including a first rotation element and a second rotation element between which a first mating face and a second mating face are formed, the first mating face being a flat surface, and the second mating face having a plurality of accommodation grooves equidistantly arranged on the second mating face, each of the plurality of accommodation grooves having a first segment and a second segment, and a depth of the first segment being more than a depth of the second segment, the second rotation element further having multiple circular loops, wherein the multiple circular loops stack together and are in a same shape, each of the multiple circular loops has a plurality of notches which do not communicate with the plurality of accommodation grooves, and each of the plurality of notches accommodates each of multiple connection columns, such that the first rotation element and the second rotation element are connected together;
wherein each of multiple locking elements is circular and is accommodated in said each accommodation groove of the second mating face, such that said each locking element moves in said each accommodation groove, wherein said each locking element has a diameter which is less than a depth of the first segment of said each accommodation groove of the second mating face and is more than a depth of the second segment of said each accommodation groove of the second mating face; and
wherein the unidirectional rotating brake further comprises at least one returning member configured to drive said each locking element to move toward the second segment of said each accommodation groove.

2. The unidirectional rotating brake as claimed in claim 1, wherein the second rotation element further has a stop ring, and the stop ring stacks on one side of the multiple circular loops so as to close said each accommodation groove.

3. The unidirectional rotating brake as claimed in claim 2, wherein the stop ring and the multiple circular loops fix said each connection columns accommodated in said each notch.

4. The unidirectional rotating brake as claimed in claim 1, wherein the at least one returning member is at least one circular flexible loop clamped among the multiple circular loops, and a profile of each of the at least one circular flexible loop corresponds to said each circular loop, said each circular flexible loop has multiple abutting portions, each of the multiple abutting portions extends into said each accommodation groove of the second mating face of the second rotation element so as to abut against said each locking element, hence said each locking element automatically moves to an original position via the second segment.

5. A unidirectional rotating brake comprising: a body including a first rotation element and a second rotation element between which a first mating face and a second mating face are formed, the first mating face being a flat surface, and the second mating face having a plurality of accommodation grooves equidistantly arranged on the second mating face, each of the plurality of accommodation grooves having a first segment and a second segment, and a depth of the first segment being more than a depth of the second segment, the second rotation element further having multiple circular loops, wherein the multiple circular loops stack together and are in a same shape, each of the multiple circular loops has a plurality of notches which do not communicate with the plurality of accommodation grooves, wherein each of the plurality of notches accommodates each of multiple connection columns, such that the first rotation element and the second rotation element are connected together; and
wherein each of multiple locking elements is circular and is accommodated in said each accommodation groove of the second mating face, such that said each locking element moves in said each accommodation groove, wherein said each locking element has a diameter which is less than a depth of the first segment of said each accommodation groove of the second mating face and is more than a depth of the second segment of said each accommodation groove of the second mating face.

6. The unidirectional rotating brake as claimed in claim 5, wherein the second rotation element further has a stop ring, and the stop ring stacks on one side of the multiple circular loops so as to close said each accommodation groove.

7. The unidirectional rotating brake as claimed in claim 6, wherein the stop ring and the multiple circular loops fix said each connection columns accommodated in said each notch.

8. The unidirectional rotating brake as claimed in claim 5 further comprising multiple springs, wherein each of the multiple springs is housed in said each accommodation groove of the second mating face, such that said each locking element moves from the first segment to the second segment in said each accommodation groove, thus moving back to an original position.

9. The unidirectional rotating brake as claimed in claim 5 further comprising multiple magnets, wherein each of the multiple magnets is accommodated in said each accommodation groove close to the second segment, and said each locking element moves toward the second segment to as to move back to an original position by using said each magnet.

10. The unidirectional rotating brake as claimed in claim 5, wherein the second rotation element has screwing threads arranged around an outer wall thereof, and said each locking element is a rolling post or a rolling ball.
